(19) United States
(12) Patent Application Publication
(10) Pub. No.: US 2010/0150481 A1
(43) Pub. Date: Jun. 17, 2010

(54) Package for consumer products

(76) Inventors: Willaim S. Perell, San Francisco, CA (US); Leif Sorenson, Cape Canveral, FL (US)

Correspondence Address: J. BENNETT MULLINAX, LLC, P. O. BOX 26029, GREENVILLE, SC, 29616-1029, US

(21) Appl. No.: 12/316,832

(22) Filed: Dec. 17, 2008

(51) Int. Cl. B65D 65/26; B65D 30/20; B65B 51/10; B42D 15/00

(52) U.S. Cl. 383/210; 383/120; 53/463; 283/56

(57) ABSTRACT

A package is made from a polymer film that includes a breachable bubble. The package can be flexible. The breachable bubble is for opening the package. In particular, the bubble, once breached, causes two opposing layers to separate. The separated layers form peelable portions that can be peeled apart in order to access the contents of the package.

### BACKGROUND

Many products, especially consumer products, are packaged in either paperboard boxes or in flexible bags made from a plastic or polymer film. Paperboard, such as cardboard, can be useful in some applications. Paperboard, for example, can produce a rigid container that can hold heavier products. Paperboard containers, however, typically have void space once loaded with a product. Thus, the paperboard packages tend to take up more space than desired, which is particularly troublesome for retail outlets that have limited shelf space.

Packages made from a polymer film, on the other hand, are generally less bulky and typically require less material in order to package the goods. Polymer films can also be wrapped tightly around the consumer products for eliminating void space. For instance, in some embodiments, polymer films are thermally formed around a product group or the product group is shrink wrapped by the polymer film.

Although packages made from polymer films can provide various advantages, opening such packages can be quite difficult. For example, the polymer films must have sufficient strength to prevent against rupture during the packaging process and during subsequent transportation. Increasing the strength of the film used to create the package, however, increases the difficulty in opening the package.

In the past, in order to facilitate the opening of packages made from polymer films, the packages typically included one or more lines of weakness or perforations where the package may be torn open by the consumer. Most perforation lines, however, are still very difficult to tear open.

In view of the above, a need currently exists for an improved flexible or semi-rigid package that is relatively easy to open. A need also exists for a package that is not only easy to open but also facilitates marketing goods contained in the package.

### SUMMARY

In general, the present disclosure is directed to a package for consumer products made from a polymer film. In accordance with the present disclosure, the package includes a breachable bubble that facilitates opening of the package. For example, applying pressure to the bubble causes a pair of opposing panels to separate. The separated panels can then be easily peeled apart in order to gain access to the interior of the package.

In one embodiment, for instance, the package includes a front panel spaced from a back panel. A hollow interior space is defined between the front panel and the back panel for containing one or more products. The package further includes a closed bottom and a top. The front panel and the back panel are made from a polymer film.

The top of the package can include a sealed tab portion where the front panel has been sealed to the back panel. The tab portion defines an opening that serves as a handle for the package. In accordance with the present disclosure, at least one breachable bubble is located in the tab portion. Breaching the bubble causes a portion of the front panel to separate from the back panel allowing the user to open the package.

The package can include a single breachable bubble or can include multiple breachable bubbles. For instance, in one particular embodiment, the package can include two breachable bubbles located on opposing sides of the opening on the sealed tab portion. Having multiple breachable bubbles may allow a consumer to access the interior of the package at different locations. Of particular advantage, the use of at least one breachable bubble eliminates the need to include any perforation lines on the package.

The breachable bubble located on the sealed tab portion can be spreadable under applied pressure. In particular, the bubble spreads into the sealed tab portion causing the front panel to separate from the back panel until the bubble produces an edge breach through the tab portion to the exterior environment. The edge breach forms peelable portions that allows the user to peel apart the front panel from the back panel and access the interior of the package for dispensing the products.

The package can have any suitable cross-sectional shape. For instance, the package can be circular or rectangular. In this regard, the front panel may comprise two separate pieces of polymer film or may comprise a single piece of polymer film that has been shaped around the consumer products. In one embodiment, the front panel can be connected to the back panel by a pair of opposing side panels.

In one embodiment, the package can include a pair of opposing gables that are located near the top of the package prior to the sealed tab portion. The gables, for instance, can comprise triangular-shaped indentations. In one embodiment, the gables can include gussets.

The package can be designed so as to lay flat either on the front panel or the back panel. For example, in one embodiment, the front and back panels on the package can be at least twice as wide as the side panels. In this arrangement, the sealed tab portion can extend outwardly when the package is resting on the back panel. The handle on the tab portion can conveniently present itself to the consumer when stacked in a retail outlet. In this regard, the package can define a central axis and the top sealed portion can intersect and be perpendicular to the central axis. In this manner, the sealed tab portion projects out from the package in a plane that is positioned at one half of the height of the package when the package is resting on the back panel.

The present disclosure is also directed to a method for packaging and marketing consumer goods. The method includes the steps of wrapping around a group of consumer products a flexible polymer film. The polymer film forms a tubular or other shaped configuration around the group of consumer products. A seam is formed along the length of the tubular configuration.

The tubular configuration can include a front panel opposite a back panel. An end of the tubular configuration can be sealed to form a bottom. The process can further include the step of sealing an opposite end of the tubular configuration to form a top. The top can include, for instance, a sealed tab portion where the front panel has been sealed to the back panel.

In accordance with the present disclosure, at least one breachable bubble is formed into the package and located in the sealed tab portion. As described above, the breachable bubble, when breached, causes a portion of the front panel from to separate from the back panel allowing a user to open the package.

Other features and aspects of the present disclosure are discussed in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a perspective view of one embodiment of a package made in accordance with the present disclosure;

FIG. 2 is a perspective view of the package illustrated in FIG. 1 showing one of the bubbles breached for opening the package; and

FIG. 3 is a perspective view of one embodiment of a process for producing packages in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present invention.

In general, the present disclosure is directed to a package for consumer products made from a polymer or plastic film and to a method of marketing or delivery a product contained in a package to consumers. In one embodiment, for instance, the walls of the package can be flexible. In the past, such packages have been relatively difficult to open. In accordance with the present disclosure, however, the package includes a breachable bubble that facilitates opening of the package. Breaching the bubble, for instance, can cause the two film layers to separate. The separated film layers can then be peeled away from each other in order to open the contents of the package in a controlled manner.

In one embodiment, the package of the present disclosure can include one or more breachable bubbles that are located on a tab portion where a handle for the package is also located. The packages can be stacked on top of each other such that the handle and a breachable bubble face outwards. In this manner, when the packages are stacked together in a retail store, the handle and breachable bubble present themselves to the consumer which can help market the package and the contents. In particular, the consumer will immediately see the breachable bubble on the package when approaching the packages down an aisle. The breachable bubble will indicate to the consumer that the package is equipped with a mechanism for easily opening the package for access to the contents. The handle of the package will also be located near the breachable bubble inviting the consumer to pull the package off the shelf for later purchase.

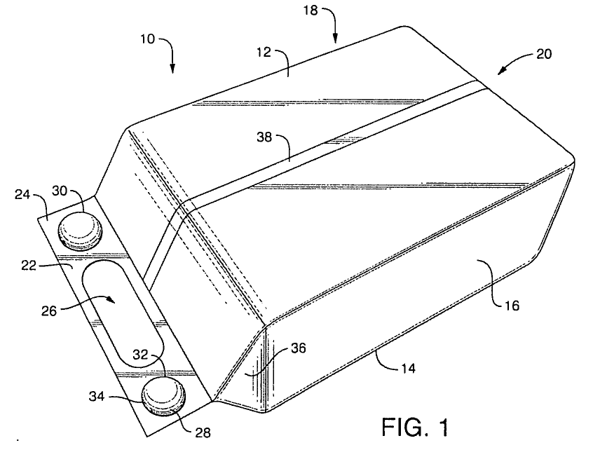

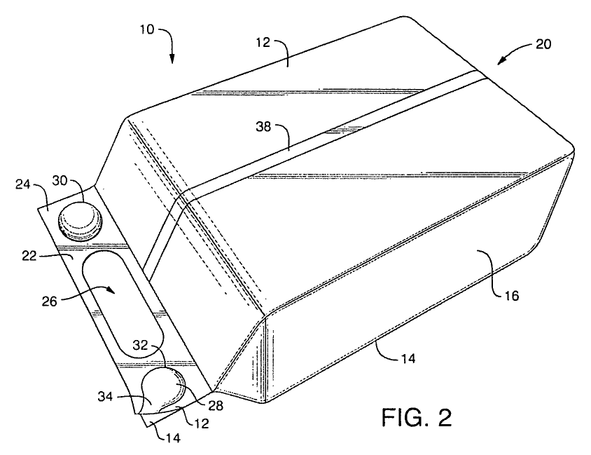

Referring to FIGS. 1 and 2, for instance, one exemplary embodiment of a package 10 made in accordance with the present disclosure is illustrated. As shown, the package 10 includes a front panel 12 spaced from a back panel 14. In this embodiment, the front panel 12 is connected to the back panel 14 by a pair of opposing side panels 16 and 18. Thus, the package 10 generally has a rectangular cross-sectional shape.

It should be understood, however, that the package 10 can have any suitable shape depending upon various factors including the type of products contained in the package. In one embodiment, for instance, the package 10 can have a circular cross-sectional shape. In this embodiment, the front panel 12 can merge into the back panel 14 without any distinctive side panels.

As shown in FIGS. 1 and 2, the package 10 can further include a bottom 20 and a top 22. In the embodiment illustrated, the top 22 includes a sealed tab portion 24 where the front panel 12 has been sealed to the back panel 14.

Each of the panels that comprise the package 10 as shown in FIG. 1 can generally be made from any suitable material. For instance, the package 10 can be made from paper, a fabric such as a woven or nonwoven material, or a film material. When made from film material, the package 10 can be made from any suitable polymer. Polymers that may be used to form the package include, for instance, polyolefins such as polyethylene and polypropylene, polyesters, polyamides, polyvinyl chloride, mixtures thereof, copolymers thereof, terpolymers thereof, and the like. In addition, the package can also be made from any suitable elastomeric polymer.

The material used to form the package 10 can comprise a single layer of material or can include multiple layers. For instance, when the package is made from a polymer film, the film can include a core layer of polymeric material coated on one or both sides with other functional polymeric layers. The other functional polymeric layers may include, for instance, a heat sealing layer for thermally bonding the film together at desired locations, an oxygen barrier layer, an ultraviolet filter layer, an anti-blocking layer, a printed layer, and the like.

When made from a polymer layer, the package 10 can be translucent or transparent. If translucent or transparent, for instance, the contents of the package can be viewed from the outside. In other embodiment, however, the package can be opaque. For instance, in one embodiment, the package 10 can display various graphics that identify, for instance, the brand and the description of the product inside.

In the embodiment illustrated in FIG. 1, the package 10 includes the sealed tab portion 24 located at the top of the package. As previously described, the top portion 24 comprises an area where the front panel 12 has been sealed to the back panel 14. As shown in FIG. 1, the tab portion 24 can define an opening 26. The opening 26 has a size sufficient to receive the hand of the user. Thus, the opening 26 can serve as a handle for the package.

In accordance with the present disclosure, the package 10 further comprises at least one breachable bubble. For example, in the embodiment shown in FIG. 1, the package 10 includes a first breachable bubble 28 and a second breachable bubble 30. In this embodiment, a breachable bubble is positioned on opposite sides of the handle 26. The breachable bubbles 28 and 30 are also positioned generally in the corner areas of the tab portion 24. It should be understood, however, that the breachable bubbles can be positioned anywhere along the tab portion.

The breachable bubbles 28 and 30 are generally formed between the back panel 14 and the front panel 12 within the tab portion 24. The bubbles 28 and 30 can be formed so as to project only upwards from the tab portion 24, only downwards from the tab portion 24, or can project upwards and downwards. Breachable bubbles that may be used in association with the package 10, for instance, are described in U.S. Pat. Nos. 6,726,364, 6,938,394, 7,306,371, and U.S. Patent Publication Numbers 2007/0284375, 2007/0235369, 2007/0286535, 2007/0237431, 2007/0295766, 2007/0241024, and 2007/0235357, which are incorporated herein by reference.

The breachable bubbles 28 and 30 are intended to produce peel away portions once breached that allow a user to access the interior of the package 10.

In one embodiment, for instance, each breachable bubble may be surrounded and defined by a seal that is at least partially breachable. For instance, as shown in FIG. 1 the breachable bubble 28 can be surrounded by a seal 32. The bubble seal 32 can include a breachable portion 34 that can face the outer most edge of the tab portion 24. The breachable portion 34 represents a portion of the bubble seal 32 that more easily separates than the remainder of the seal. The breachable portion 34 can be made using any suitable method or technique. For instance, if the bubble seal 32 is made using an adhesive, less adhesive may be used along the breachable portion 34. If, alternatively, the bubble seal 32 comprises a thermal bond or an ultrasonic bond, the breachable portion 34 may be made by varying the pressure of the seal bar, varying the temperature or varying the amount of time the seal bar is in contact with the material along the breachable portion. In still another embodiment, the breachable portion 34 or the entire bubble seal 32 may comprise a peel seal. Constructing the bubble seal 32 as a peel seal will allow the bubble to be reattached if breached.

Various different methods and techniques can be used to form peel seals. For example, in one embodiment, the breachable portion of the bubble seal or the entire bubble seal may include a first portion that is adhesively secured to a second portion along the seal. The first portion may be coated with a pressure sensitive adhesive. The adhesive may comprise, for instance, any suitable adhesive, such as an acrylate.

The second and opposing portion of the peel seal, on the other hand, may comprise a film coated or laminated to a release layer. The release layer may comprise, for instance, a silicone.

When using an adhesive layer opposite a release layer as described above, the bubble seal is resealable after the bubble is breached.

In an alternative embodiment, each opposing portion of the peel seal may comprise a multi-layered film. The major layers of the film may comprise a supporting layer, a pressure sensitive adhesive component, and a thin contact layer. In this embodiment, the two portions of the peel seal can be brought together and attached. For instance, the thin contact layer of one portion can be attached to the thin contact layer of the opposing portion using heat and/or pressure. When the locking bubble is breached, and the peel seal is peeled apart, a part of the sealed area of one of the contact layers tears away from its pressure sensitive adhesive component and remains adhered to the opposing contact layer. Thereafter, resealing can be affected by re-engaging this torn away contact portion with the pressure sensitive adhesive from which it was separated when the layers were peeled apart.

In this embodiment, the contact layer can comprise a film having a relatively low tensile strength and having a relatively low elongation at break. Examples of such materials include polyolefins such as polyethylenes, copolymers of ethylene and ethylenically unsaturated comonomers, copolymers of an olefin and an ethylenically unsaturated monocarboxylic acid, and the like. The pressure sensitive adhesive contained within the layers, on the other hand, may be of the hot-melt variety or otherwise responsive to heat and/or pressure. In still another embodiment, the breachable portion of the bubble seal or the entire bubble seal can include a combination of heat sealing and adhesive sealing. For instance, in one embodiment, the bubble seal may comprise a first portion that is heat sealed to a second portion. Along the breachable portion, however, may also exist a peel seal composition that may, in one embodiment, interfere with the heat sealing process of the bubble seal to produce a breachable portion. The peel seal composition, for instance, may comprise a lacquer that forms a weak portion along the bubble seal.

In an alternative embodiment, an adhesive may be spot coated over the length of the breachable point. Once the breachable portion is breached, the adhesive can then be used to reseal the two portions together after use.

The breachable bubbles 28 and 30 are expandable to open the package 10 by external pressure applied by a consumer. For small bubbles, the consumer may simply pinch a bubble or bubbles between his or her thumb and forefinger. Slightly larger bubbles may require thumb-to-thumb pressure. Pressure can also be applied to the bubble by placing the bubble against a flat surface and applying pressure with one's fingers or palm.

In one embodiment, as shown in FIG. 2, applying pressure to the bubble 28 causes the bubble to spread into the sealed tab portion 24. More particularly, spreading occurs over the breachable portion 34 causing the front panel 12 to separate from the back panel 14. Separation occurs along the breachable portion 34 until an edge breach is created as shown in FIG. 2.

Once the front panel 12 is separated from the back panel 14, each panel forms a peelable portion. A user can then grasp each peelable portion and peel the two panels apart until an access opening is formed in the package. The access opening can then be used to remove the product contained in the package.

In one embodiment, the package 10 can include a single breachable bubble for opening a portion of the top of the package or for opening the entire length of the top. Including two breachable bubbles 28 and 38 as shown in FIG. 2, however, allows the user to gain access to one side of the package or to the other side of the package as desired.

In general, the breachable bubbles 28 and 30 can have any suitable shape. For example, the bubbles can be circular as shown in the figures. In other embodiments, however, the bubbles can have a triangular shape, a rectangular shape, or can even have a heart-like shape. In still other embodiments, the bubble can be in the shape of an oval. Further, the bubble can be relatively small on the package or can be relatively large. For instance, in one embodiment, the bubble can extend over greater than fifty percent of the length of the tab portion 24.

In the embodiment illustrated in FIG. 2, the bubble 28 includes a breachable portion 34 that creates an edge breach approximately at the corner of the package. It should be understood, however, that the bubble can operate to separate the front panel 12 from the back panel 14 in other ways. For example, in an alternative embodiment, the bubble can “pop” without spreading thereby forming peelable portions that can be used to open the package.

As described above, the package 10 as shown in FIG. 1 can have any suitable shape. In the embodiment illustrated, the package is generally rectangular. In order to form the tab portion 24, the package includes a pair of opposing gables including gable 36. The gable 36 can include an indented portion and can include a gusset.

In one embodiment, the gusset on each side of the package can extend into the tab portion 24. In this embodiment, the tab portion 24 will include lateral side margins that comprise four layers of material. In particular, the side margins will include a folded portion used to form the gusset below the outer layers of the tab portion. In this embodiment, the bubble can be formed between any of the four layers. For instance, the bubble can be formed in between an outer layer and the gusset, can be formed internally between the gusset materials, or may extend all the way through all four layers. In an alternative embodiment, the bubble may be positioned outside of the lateral margins such that the bubble is only positioned where the tab portion comprises two layers of material.

In one embodiment, as shown in FIG. 1, the handle 26 can be conveniently located such that the handle presents itself to the consumer in a retail aisle. For example, the handle can be located such the handle intersects and is substantially perpendicular to a central axis of the package 10. In this manner, the handle can lie in a plane that is substantially one half the height of the side panels 16 and 18. Thus, when the package is laying on the back panel 14, the handle projects out from the package so that a consumer can easily grasp and pick up the package, especially when stacked on a shelf.

The generally rectangular shape of the package may also assist in allowing multiple packages to be stacked together. In this regard, the front panel 12 and back panel 14 can be substantially larger than the side panels 16 and 18. For instance, the width of the front and back panels can be at least twice as wide as the side panels 16 and 18. For instance, the front and back panels can be from about two times to about four times wider than the side panels in certain embodiments.

In one embodiment, the package can actually be used to help market a consumer product contained in the package. For instance, a plurality of the packages can be stacked together in a retail outlet as described above. In particular, the packages can be stacked such that the tab portion faces outward from the stack and thus would face a consumer approaching the stack in the retail outlet. In this manner, not only will the consumer visibly see the breachable bubbles on the packages but can also easily grab a package by the handle in order to remove the package from the stack.

The package can be removed from the top of the stack or can be removed from the bottom of the stack. For instance, in one embodiment, a package dispenser may be included that includes various graphics for advertising the product. The container can include an opening at the bottom from which the product is dispensed which presents to the consumer not only the handle but also the breachable bubble thereby indicating that the package can be easily opened once purchased.

In one embodiment, the breachable bubble contained on the package can also include various features that may further assist in selling the products. For instance, in one embodiment, the bubble can be constructed so as to make an audible popping sound when popped. In another embodiment, the breachable bubble can contain a coupon, a prize, a product sample, a fragrance, a promotion, or the like which is accessed when the bubble is breached.

Of particular advantage, the package can also be constructed from a single piece of polymer film. In particular, the polymer can be wrapped around one or more products to form a seam 38. The seam can extend from the bottom 20 of the package 10 to the top 22. In the embodiment illustrated in FIGS. 1 and 2, the seam 38 is shown on the front panel 12. In other embodiments, however, it may preferable to locate the seam on the back panel 14. The seam 38 can comprise an overlap seal or a fin seal depending on the particular application.

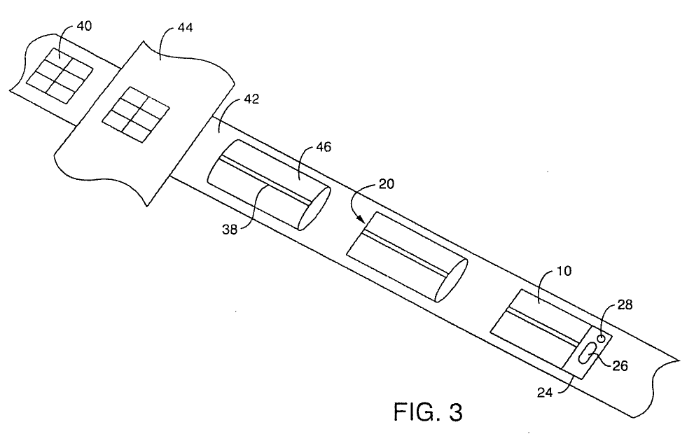

Although the package 10 can be constructed using various different methods and techniques, one particular embodiment of a process for packaging a group of products in accordance with the present disclosure is illustrated in FIG. 3. As illustrated, a group of products 40 are conveyed along a conveyor 42. The products 40 can then be directed onto a polymer film 44 that is wrapped around the products. The polymer film 44 can be supplied from a roll that is cut to a desired length.

A stationary or moving folding device can wrap the polymer film 44 around the products 40 to form a tubular configuration 46. A seam 38 is formed along the tubular configuration 46. The seam 38 can be formed using any suitable method such as by thermally bonding the material together, ultrasonically bonding the material together, or adhesively bonding the material together.

In the embodiment illustrated in FIG. 3, the bottom 20 of the package is then formed around the products. The bottom 20 can be formed by sealing the package along the width of the package or by folding and sealing the package. In one embodiment, for instance, opposing gables can be formed into the bottom 20 if desired.

As shown in FIG. 3, after the bottom 20 is sealed, the top tab portion 24 may be formed using any of the methods described above. For instance, the tab portion may be formed using thermal bonds, ultrasonic bonds, or adhesive bonds. While the tab portion 24 is being formed, a breachable bubble 28 can also be formed into the package. The breachable bubble is formed in between the two layers that form the tab portions. Air or any suitable gas can be trapped or injected into the bubble 28 so that the bubble is at least partially inflated.

As shown in FIG. 3, an opening can also be cut into the tap portion 24 for forming the handle 26.

It should be understood that the order of operations to form the package 10 can vary. For instance, in an alternative embodiment, the tab portion 24 may be first formed and the bottom 20 may be closed or sealed at a later time. Further, many of the operations can be performed simultaneously.

Of particular advantage, the package 10 can be formed from a single piece of material and can be formed continuously on a conveyor line. Further, as described above, no perforations need to be formed into the package since the bubble 28 provides a simple and easy means for opening the package.

The package 10 can be formed so as to be liquid tight and/or gas tight. Further, the interior of the package can be at atmospheric pressure, above atmospheric pressure, or below atmospheric pressure. For instance, in one embodiment, the contents of the package can be vacuum sealed.

The package 10 as shown in FIG. 1 can contain any suitable product or item without limitation. Consumer products that may be contained in the package, for instance, include food items, general merchandise, hardware, tissue products, absorbent articles such as diapers and feminine care products, and the like. Landscaping supplies such as soil amendments, potting soil, mulch, and the like can also be contained in the package. In still another alternative embodiment, a liquid can be contained in the package that is not contained in separate containers.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A package for consumer products comprising:
a front panel spaced from a back panel and defining a hollow, interior space therebetween, the package further including a closed bottom and a top;
the front panel and the back panel being made being from a polymer film, the top including a sealed tab portion where the front panel has been sealed to the back panel, the tab portion defining an opening that serves as a handle for the package; and
at least one breachable bubble located in the tab portion, and wherein breaching the bubble causes a portion of the front panel to separate from the back panel allowing a user to open the package.

2. A package as defined in claim 1, wherein the back panel is connected to the front panel by a pair of opposing side panels.

3. A package as defined in claim 1, wherein the polymer film is flexible.

4. A package as defined in claim 1, wherein the package includes only a single breachable bubble.

5. A package as defined in claim 1, wherein the package includes a first breachable bubble and a second breachable bubble, the bubbles being positioned on opposing sides of the opening.

6. A package as defined in claim 1, wherein the package is made from a single piece of polymer film.

7. A package as defined in claim 6, further comprising a seam that extends from the top to the bottom of the package.

8. A package as defined in claim 7, wherein the seam is located on the back panel.

9. A package as defined in claim 1, wherein the package does not contain any perforations.

10. A package as defined in claim 1, wherein the package further includes a pair of opposing gables located near the top of the package prior to the sealed tab portion.

11. A package as defined in claim 10, wherein each of the gables includes a gusset.

12. A package as defined in claim 2, wherein the front and back panels are at least twice as wide as the side panels.

13. A package as defined in claim 12, wherein the front and back panels are from two times to four times wider than the side panels.

14. A package as defined in claim 1, wherein the breachable bubble is spreadable under applied pressure into the sealed tab portion, spreading of the bubble causing the front panel to separate from the back panel until the bubble produces an edge breach through the tab portion to the exterior environment.

15. A package as defined in claim 14, wherein the edge breach forms peelable portions for separating the front panel from the back panel in the tab portion for opening the package.

16. A package as defined in claim 1, wherein the package has a circular cross-sectional shape.

17. A package as defined in claim 1, wherein the package defines a central axis and wherein the top sealed portion intersects and is perpendicular to the central axis.

18. A package as defined in claim 2, wherein the side panels define a height of the package and wherein the sealed tab portion is located in a plane that is positioned at one-half the height of the package.

19. A process for packaging consumer goods comprising:
wrapping around a group of consumer products a flexible polymer film, the polymer film forming a tubular configuration around the group of consumer products;
forming a seam along a length of the tubular configuration, the tubular configuration including a front panel opposite a back panel and defining an interior volume therebetween where the consumer products are located;
sealing an end of the tubular configuration to form a bottom;
sealing an opposite end of the tubular configuration to form a top, the top including a sealed tab portion where the front panel has been sealed to the back panel;
forming an opening in the sealed tab portion, the opening comprising a handle; and
forming a breachable bubble within the sealed tab portion, and
wherein, breaching the bubble causes a portion of the front panel to separate from the back panel for later opening the package.

20. A process as defined in claim 19, further comprising the step of forming a pair of opposing gables into the package adjacent to the sealed tab portion.

21. A method of marketing a consumer product comprising:
enclosing a consumer product in a package, the package including a front panel spaced from a back panel and defining a hollow, interior space therebetween, the package including a closed bottom and a top, the package further including a tab portion located along the top of the package, the tab portion defining an opening that serves as a handle and including at least one breachable bubble, and wherein breaching the bubble causes the tab portion to separate for allowing a user to open the package; and
stacking a plurality of the packages together in a retail outlet, the packages being stacked such that the tab portion faces outwards from the stack so that a consumer can remove the package from the stack by grasping the handle.

22. A method as defined in claim 21, wherein the packages are stacked such that a back panel of one package is placed on a front panel of an adjacent package.

23. A method as defined in claim 21, wherein the breachable bubbles located on the tab portion are visible to a consumer approaching the stack.

24. The method set forth in claim 21 further including the step of:
providing said bubble in such a manner that when said bubble is breached, an audible popping sound is made.

25. The method as set forth in claim 22 further including the step of:
providing within said bubble one of a coupon, prize, product sample, fragrance, and promotion which is accessed upon breaching said bubble.
